(19) United States
(12) Patent Application Publication
(10) Pub. No.: US 2024/0045052 A1
(43) Pub. Date: Feb. 8, 2024

(54) METHOD, APPARATUS AND RADAR SYSTEM FOR TRACKING OBJECTS

(71) Applicant: Symeo GmbH, Neubiberg (DE)

(72) Inventors: Johannes TRAA, Medford, MA (US); Atulya YELLEPEDDI, Medford, MA (US); Peter GULDEN, Erding (DE); Andrew SCHWEITZER, Cambridge, MA (US)

(21) Appl. No.: 18/256,823

(22) PCT Filed: Dec. 1, 2021
(86) PCT No.: PCT/EP2021/083747

§ 371 Date: Jun. 9, 2023

Related U.S. Application Data
(60) Provisional application No. 63/123,403, filed on Dec. 9, 2020.

(30) Foreign Application Priority Data
Mar. 9, 2021 (DE) 10 2021 105 659.4

(51) Int. Cl. G01S 13/72; G01S 13/93; G01S 7/41; G01S 13/58

(52) U.S. Cl. CPC G01S 13/726; G01S 13/93; G01S 7/411; G01S 13/589

(57) ABSTRACT

Detection points may be first observed over multiple radar frames. The observed detection points, which form the tracklets, can be used to form a segmentation of the present radar frame by associating the tracklats to at least one object-track, which represents at least one object based on at least one feature-parameter. Segmentation results from tracking of detection points over multiple radar frames (viz. utilizing tracking information) which is used for associating detection points to objects (segmentation-by-tracking). A two-level tracking approach can be implemented, in which for a present radar frame, (new) detection points are associated to tracklets, which may be seen as a first level, and then the tracklets are associated to object-tracks, which may be seen as a second level.

### FIELD OF THE DISCLOSURE

The present disclosure generally relates to methods, systems, vehicles, and apparatus for tracking at least one object in measurement data of a radar system and, more particularly, a radar system configured to track at least one object in its measurement data.

### BACKGROUND

In the field of autonomous or quasi-autonomous operation of vehicles such as aircrafts, watercrafts or land vehicles, in particular automobiles, which may be manned or unmanned, sensing the surrounding of the vehicle as well as tracking objects in the surrounding of the vehicle may be considered to be crucial for sophisticated functionalities. These functionalities may range from driver assistance systems in different stages of autonomy up to full autonomous driving of the vehicle.

In the certain environments, a plurality of different types of sensors for sensing the surrounding of a vehicle are used, such as monoscopic or stereoscopic cameras, light detection and ranging (LiDAR) sensors, and radio detection and ranging (radar) sensors. The different sensor types comprise different characteristics that may be utilized for different tasks.

Embodiments of the present disclosure concern aspects of processing measurement data of radar systems, whereby the computationally heavy fusion of different sensor type data can be avoided.

Radar systems may provide measurement data, in particular range, doppler, and/or angle measurements (azimuth and/or elevation), with high precision in a radial direction. This allows one to accurately measure (radial) distances as well as (radial) velocities in a field of view of the radar system between different reflection points and the (respective) antenna of the radar system.

Radar systems, basically, transmit (emit) radar signals into the radar system's field of view, wherein the radar signals are reflected off of objects that are present in the radar system's field of view and received by the radar system. The transmission signals are, for instance, frequency modulated continuous wave (FMCW) signals. Radial distances can be measured by utilizing the time-of-travel of the radar signal, wherein radial velocities are measured by utilizing the frequency shift caused by the doppler effect.

By repeating the transmitting and receiving of the radar signals, radar systems are able to observe the radar system's field of view over time by providing measurement data comprising multiple, in particular consecutive, radar frames.

An individual radar frame may for instance be a range-azimuth-frame or a range-doppler-azimuth-frame. A range-doppler-azimuth-elevation-frame would be also conceivable, if data in the elevation-direction is available.

In each of the multiple radar frames a plurality of reflection points which may form clouds of reflection points can be detected. However, the reflection points or point clouds, respectively, in the radar frames do not contain a semantic meaning per se. Accordingly, a semantic segmentation of the radar frames is necessary in order to evaluate (“understand”) the scene of the vehicle's surrounding.

The segmentation of a radar frame means that the single reflection points in the individual radar frames are assigned a meaning. For instance, reflection points may be assigned to the background of the scene, foreground of the scene, stationary objects such as buildings, walls, parking vehicles or parts of a road, and/or moving objects such as other vehicles, cyclists and/or pedestrians in the scene.

In the prior art, semantic image segmentation is, usually, performed in images obtained by a camera sensor (camera frames), as, inter alia, described in “No Blind Spots: Full-Surround Multi-Object Tracking for Autonomous Vehicles using Cameras & LiDARs” by Akshay Rangesh and Mohan Trivedi.

In camera frames, it is beneficial for the semantic segmentation that most of the light reflects diffusely into the sensor so that continuous regions can be observed in the camera frame. However, the semantic segmentation in radar images is particularly difficult.

Generally, radar systems observe specular reflections of the transmission signals that are emitted from the radar system, since the objects to be sensed tend to comprise smoother reflection characteristics than the (modulated) wavelengths of the transmission signals.

Consequently, the obtained radar frames do not contain continuous regions representing single objects, but rather single prominent reflection points (such as the edge of a bumper), distributed over regions of the radar frame.

For the tracking of objects in the scene (in the radar system's field of view), which is the pursuing of an object over multiple frames, it becomes even more difficult, since the single reflection points that may belong to an object may vary from radar frame to radar frame. This means, for instance, that reflection points in a first radar frame may disappear in a second, e.g. (immediately) subsequent, radar frame, while other reflection points may appear in the second radar frame.

In light of the above, the objective of embodiments of the present disclosure are to provide a method for tracking at least one object in radar frames of a radar system, and a corresponding radar system, wherein objects of interest are tracked in an efficient and reliable manner.

Objectives of embodiments of the present disclosure can be achieved, in particular, by the method for tracking at least one object in measurement data of a radar system according to claim 1.

### SUMMARY OF THE DISCLOSURE

In particular, one objective of the present disclosure is solved by a method, according to an embodiment of the present invention, for tracking at least one object in measurement data of a radar system including a plurality of, in particular consecutive, radar frames acquired by a radar system, comprising:
detecting detection points in the radar frames;
associating the detection points of a present radar frame to a plurality of tracklets, wherein each tracklet is a track of at least one detection point observed over multiple radar frames; and
associating (in particular grouping) the tracklets based on at least one feature-parameter to at least one object-track (representing the at least one object to be tracked).

An aspect of the present disclosure is based on the idea that in the radar frames, detection points may be first observed over multiple radar frames, wherein the observed detection points, which form the tracklets, can be used to form a segmentation of the present radar frame by associating the tracklets to at least one object-track, which represents at least one object based on at least one feature-parameter.

The segmentation according to the inventive method results from the tracking of detection points over multiple radar frames (viz. utilizing tracking information) which is used for associating detection points to objects (segmentation-by-tracking).

Accordingly, the present method can be regarded as a two-level-approach, in which for a present radar frame, (new) detection points are associated to tracklets, which may be seen as a first level (of the tracking method), and then the tracklets are associated to object-tracks, which may be seen as a second level (of the tracking method).

One method according to the present disclosure differs from the conventional approach, in which each radar frame is usually treated independently in one level by segmentation without using tracking information for the segmentation.

Detecting of detection points may be understood as finding intensity peaks in the radar frame, wherein the radar frames may be understood as a three-dimensional intensity map, for instance in an angle-range bin or an angle-doppler-range bin. The term “detection point” should not to be understood as zero-dimensional point in a geometrical sense, but should preferably be understood as a region of the above-mentioned intensity peak (e.g. relating to an edge of a bumper or any other structure, in particular edge and/or corner of a vehicle, in particular a region with prominent reflection). The detection point may comprise at least one, in particular a plurality of resolution cells (e.g. pixels and/or voxels) in the radar frame.

The measurement data acquired by a radar system can be a two-dimensional, or multi-dimensional, complex-valued array comprising dimensions that include the (azimuth and/or elevation) angle, the (radial) velocity (also named doppler), and radial distance (also named range). For instance, it is possible to use the magnitude in each angle-doppler-range bin to describe how much energy the radar sensor receives from each point in the scenery (in the field of view) for a radial velocity.

Consecutive radar frames may be understood as a plurality of radar frames wherein each radar frame (except for a first radar frame) follows another radar frame in time. Of a given (measured or determined, respectively) plurality of radar frames, all radar frames can be used or only a sub-set of the radar frames.

In particular, obtaining and/or maintaining the tracklets and the object-tracks is based on at least one dynamical system model, whereby a robust and accurate tracking of the tracklets and the object-tracks can be achieved.

The at least one dynamical system model may be utilized to estimate at which position in a radar frame, in particular a subsequent radar frame, a tracklet and/or an object-track may be expected.

Preferably, the method further comprises the following steps:
predicting one or a plurality of parameters of each tracklet for the present radar frame by propagating the dynamical system model, wherein the parameters of each tracklet include at least a position, in particular a position and a velocity, preferably a position and a velocity and an acceleration, and a covariance of the tracklet in a radar frame; and
correcting the parameters of each tracklet based on the detection points that are associated to the corresponding tracklet.

Preferably the predicting is performed before the associating of the detection points to the tracklets and the correcting is performed after the associating of the detection points to the tracklets.

By predicting the parameters of the tracklets before the associating of the detection points, it is possible to improve the associating of the detection points to the tracklets. By correcting the parameters of the tracklets after the associating of the detection points, it is possible to correct the model inaccuracies, whereby the performance of the tracking solution may be improved.

In particular, a detection point is associated to a tracklet in the associating of the detection points to tracklets step, if a position of the detection point is within a gate of a tracklet; wherein new tracklets are initialized from the detection points whenever the criterion for assignment of a detection is not met for any of the existing tracklets, in particular if a position of a detection point is outside of the gates of all existing tracklets.

The above-described method for associating detection points to tracklets is particularly simple and computationally lightweight. The gate of a tracklet may be an association-region, such as a polytope (e.g. polygon, in particular tetragon, or polyhedron, in particular hexahedron), in particular a, preferably rectangular, parallelotope (e.g. parallelogram, in particular rectangle or square, or parallelepiped, in particular cuboid or cube), an (hyper-)ellipsoid or an ellipse or a (hyper-)sphere or a circle (in particular depending on the dimensions of the corresponding frame(s)).

New tracklets are preferably initialized from unassociated detection points, which are detection points that are not associated to a tracklet, viz. the unassociated detection points are not within any gate of the tracklets (which is preferably the criterion for assignment). This allows a simple, yet fast and effective, method for initialization of new tracklets.

Preferably, a gate for each tracklet is either fixed in size or is adaptive in size. If it is adaptive, the size of the gate may correlate with the covariance of the tracklet, in particular such that the size of the gate is increased if the covariance increases, and vice versa.

Accordingly, it is possible to vary the gate of the tracklets in size depending on the covariance of the predicted position of the tracklet in the present radar frame. This further enhances the associating of the detection points to the tracklets, since the amount of false associations between detection points and tracklets may be reduced, in particular if the position of a tracklet is predicted with a higher certainty (which correlates with a higher covariance).

It is preferred that in the associating of the detection points to the tracklets, a detection point is associated to the tracklet having a position closest to the detecting point.

This enables a simple, yet effective, method for associating the detection points to the tracklets.

Alternatively, or additionally, a detection point may be probabilistically associated to multiple tracklets in the associating of the detection points to tracklets. Preferably probabilistic values determining the probability that a detection point is associated to a tracklet are increased if the distance between the position of the detection point and the predicted position of the tracklet decreases, and vice versa.

For instance, the Mahalanobis distance may be used as a measure for associating the detection points to the tracklets.

The associating of detection points to multiple tracklets is particularly beneficial in difficult associating situations, for instance if detection points are within two or more gates of different tracklets.

In particular, the feature-parameter for the associating (grouping) of the tracklets, based on which the tracklets are clustered into the object-tracks, comprises an overlap of the gates of the individual tracklets in at least the present radar frame and/or a summed overlap of the gates of the individual tracklets in multiple previous radar frames.

The overlap of the gates of the individual tracklets in at least the present radar frame and/or a (summed) overlap of the gates of the individual tracklets in multiple previous radar frames, as feature-parameter(s), is a meaningful criterion for associating (grouping) tracklets to object-tracks.

In particular, using the summed overlap of the gates of the individual tracklets in multiple previous radar frames as the feature-parameter may enhance the robustness of the association.

Preferably, the associating (grouping) of the tracklets is performed by a clustering method, in particular by a Density-Based Spatial Clustering of Applications with Noise (DBSCAN) method, which is a simple yet effective clustering method.

It is preferred that the method further comprises correcting parameters of the object-track, in particular, a position, a velocity and/or an acceleration of the object-track, by updating the parameters of the object-track based on a predicted velocity and/or a predicted acceleration of the tracklets of the corresponding object-track.

Accordingly, it is possible to enhance the tracking solution of object-tracks by using the predicted parameters of the tracklets that are associated to the object-tracks as measurements for the object-tracks.

Particularly, each tracklet comprises metadata including at least one of a status of the tracklet, a track-count value and a lost-track-count value. Preferably, the metadata of the tracklets also include an identification number that identifies which object-track the tracklet is associated to.

The status may differ by a state of the tracklet which can be, for example, one of a tracked and non-tracked (e.g. lost or, respectively, no longer tracked) state, or, one of a tentative state, a tracked state and a (at least intermediately) lost state, or one of a tentative state, a tracked state, a (at least intermediately) lost state and a completely lost state.

More particularly, the method further comprises the following steps:
updating the metadata of the tracklets; and
initializing detection points as new tracklets that are not associated to existing tracklets,
   wherein the updating of the metadata and the initializing of detection points as new tracklets are performed after the associating of the detection points to the tracklets.

Preferably, different filters are used for modelling the dynamics of the tracklets and for modelling the dynamics of the object-tracks. Preferably the filter for modelling the dynamics of the tracklets is less computationally intensive than the filter for modelling the dynamics of the object-tracks.

Preferably, an alpha-beta filter is used for modelling the dynamics of the tracklets and a Kalman filter is used for modelling the dynamics of the object-tracks, whereby a reasonable trade-off between the computational demand and the performance of the tracking results can be achieved.

Alternatively, an alpha-beta filter is respectively used for modelling the dynamics of the tracklets and the object-tracks, whereby the computational demands can be further decreased.

Alternatively or additionally, an object model may be inferred from a library of object models for each object-group and a switching Kalman filter may be used for modelling the object-tracks, wherein a switch state of the switching Kalman filter represents an object class.

For instance, the library of object models may include object models for vehicles, such as automobiles or trucks, cyclists, or pedestrians.

This may enable the distribution of the object over a region in the radar frame to be inferred, which may improve the accuracy of the associating of the detection points to the tracklets as well as the associating of the tracklets to the object-tracks. Additionally, or alternatively, this may enable the dynamical system models to be switched in correspondence with the object models so that the modelling of the dynamics of the objects can be adapted to the object that is tracked.

Preferably, the class-specific object models are learned (derived) from data sets. It is also conceivable that an object classifier, such as a support-vector-machine (SVM), neuronal networks, or (deep) convolutional neuronal network (CNN), can be used to classify an object-track into one of the object classes of the library.

In a further (independent or dependent) aspect of the present disclosure, one object of the disclosure is solved in particular by a radar method, wherein the (or, if an independent aspect: a) plurality of radar frames comprised in the measurement data is a first plurality of radar frames acquired by a first radar unit, wherein the measurement data further includes a second plurality of radar frames acquired by a second radar unit that is non-colocated (and/or non-coherent) to the first radar unit, wherein the first and the second plurality of radar frames are synchronized (in time) and at least partially overlap (spatially), wherein the radar frames contain range, doppler and angle measurements, wherein a multidimensional velocity vector is determined from the doppler measurements for at least one, in particular for multiple, preferably for each detection point that is detectable in synchronized radar frames of the first and the second plurality of radar frames, wherein the determining of the multidimensional velocity vector is based on the corresponding doppler measurements of the first and the second radar units. In this further aspect, the two-level-tracking approach is preferred but not mandatory (i.e. any following embodiments of the further aspect may relate to said two-level-tracking or may relate to any other, e.g. one-level or conventional, tracking method).

The multidimensional velocity vector may be used to expedite the initializing of new (object-)tracks, which can be especially advantageous when objects quickly appear in the field of view of the radar system.

In particular, the multidimensional velocity vectors are used in a correcting of parameters of a track, in particular in the correcting of the parameters of the tracklet (t1 to tm).

More particularly, the multidimensional velocity vectors are used in an (the) the updating of (the) metadata of tracks (in particular the tracklets). Further, they may be used in the initializing of detections (detection points) as new tracks (tracklets), whereby the updating of the metadata of the tracks (tracklets) and the initializing of detection points as new tracks (tracklets) can be expedited. In particular, a transition of the status of the respective track (tracklet) from a tentative state to a tracked state can be expedited.

It is preferred that the status of a track (tracklet) is changed immediately from a tentative state to a tracked state if the track (tracklet) is inside an area around the position of a detection point for which a multidimensional vector is determined, and if a comparison measure, in particular a sum of the inner product, of the multidimensional velocity vector and multidimensional velocity vectors of the detection point's neighboring multidimensional velocity vectors, is equal to or greater than a predetermined threshold.

Accordingly, it can be determined if the multidimensional velocity vectors of neighboring detection points are at least approximately congruent. If the multidimensional velocity vectors of neighboring detection points are at least approximately congruent, it can be assumed that the neighboring detection points refer to one track (tracklet).

One objective of the present disclosure is further solved by a radar system configured to track at least one or multiple objects in measurement data of the radar system including a plurality of, in particular consecutive, radar frames using a method of the above-described type, comprising:
a first radar unit configured to acquire a plurality of radar frames by transmitting and receiving radar signals reflected on potential objects to be tracked in a field-of-view of the first radar unit; and
a tracking computation unit configured to process the acquired radar frames by performing the steps of a method of the above-described type.

Preferably, the radar system further comprises the following:
a second radar unit configured to acquire a plurality of radar frames by transmitting and receiving radar signals reflected on potential objects to be tracked in a field-of-view of the second radar unit.

Preferably, the field of view of the first radar unit and the field-of-view of the second radar unit at least partially overlap.

The radar system may comprise one or more (e.g. at least two or at least four) antennas for transmitting and/or receiving radar signals. Any of the first and/or the second radar unit may comprise one or more (e.g. at least two or at least four) antennas for transmitting and/or receiving radar signals.

Moreover, an objective of the present disclosure is solved by a vehicle in which a radar system of the above-described type is mounted, wherein the vehicle is an aircraft and/or watercraft and/or land vehicle, preferably an automobile, wherein the vehicle may be manned or unmanned.

Features and related advantages described in connection with the inventive method for tracking at least one object in measurement data of a radar system, are applicable and transferable to the radar system or vehicle of the present disclosure. The process steps explained above can be realized in the radar system or vehicle as corresponding configurations (e.g. a control and/or computing unit) individually, or in combination.

Further advantageous embodiments may be found in the sub-claims.

### BRIEF DESCRIPTION OF THE DRAWINGS

In the following, the present disclosure is further explained by means of non-limiting embodiments or examples, with reference to the attached drawings. The figures outline the following:

FIG. 1 shows a flowchart of an example of the method for tracking at least one object in a plurality of radar frames according to the invention;

FIG. 2 shows a schematic representation of an example of a radar system according to the invention;

FIG. 3A shows an example of a present radar frame on which step S1 of the method for tracking at least one object is performed;

FIG. 3B shows an example of a present radar frame on which step S2 and step S3 of the method for tracking at least one object is performed;

FIG. 3C shows an example of a present radar frame on which step S4 of the method for tracking at least one object is performed;

FIG. 4 shows a schematic representation of a further radar system according to the invention.

### DETAILED DESCRIPTION

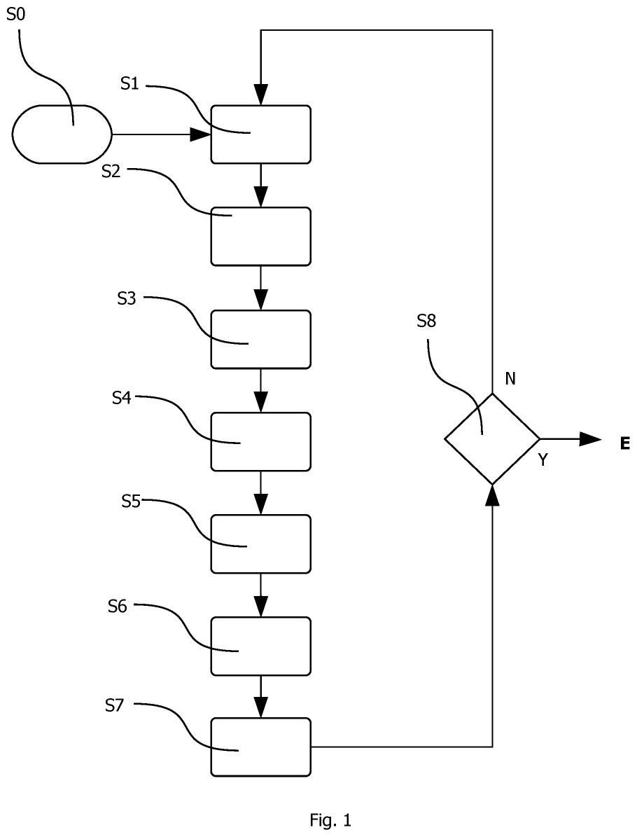

In FIG. 1, a flowchart of an example of the method for tracking at least one object in a plurality of radar frames according to the present disclosure is depicted. In this example the method steps S0 to S8 are performed, wherein steps S1 to S8 form a tracking loop. Y is short for “Yes”, N is short for “No”, and E is short for “End”.

In method step S0, the tracking loop is initialized by creating empty lists for the tracklets as well as for the object-tracks.

After initializing the tracking loop, the method steps of the tracking loop S1 to S8 are performed until the last radar frame to be processed is reached. If the last radar frame to be processed is reached, the tracking loop is terminated in step S8.

In the tracking loop, method step S1, which is detecting detection points d in a first radar frame f1, is performed. In this example, the radar frames are (at least basically) heat maps in which the (radial) velocity is drawn over the range and angle measurements.

In practice, the radar frames are pre-processed by using methods for suppressing noise and artifacts, as well as methods for extracting salient regions in the radar frame. These methods, for instance, involve estimating either a background model and removing the modelled background from the radar frame, or creating a mask that emphasizes desired regions and suppresses others through element-wise multiplication.

For instance, the method of Constant False Alarm Rate (CFAR) thresholding can be used for pre-processing the radar frame, which involves estimating a background model through local averaging. The basic idea here is that noise statistics may be non-uniform across the array (radar frame).

Another possible variation of the above method would be Cell Averaging- (CA-) CFAR, in which a moving mean is computed whilst a region at the center of the averaging window (guard cells) is excluded to avoid including a desired object in the background estimate. Moreover, Order Statistic- (OS-) CFAR is a variation of CA-CFAR, wherein a percentile operation is used instead of a mean operation.

Moreover, methods that use time-adaptive background modeling may also be used for preprocessing the radar frames. For example, a multi-tap, preferably a 5-tap, particularly a 3-tap, more particularly a 2-tap, Infinite Impulse Response (IIR) filter for smoothing the foreground detection causally through time, may be applied to avoid the necessity of re-computing the entire background model at each radar frame.

After the pre-processing of the radar frames by using a thresholding method as described above, foreground regions are extracted in the radar frame. However, some spurious peaks may still exceed the threshold. The spurious peaks can be removed by assuming that all regions of interest may be considered as three-dimensional blob shapes.

In this example, the detecting of the detection points comprises finding local maxima in the pre-processed radar frames after extracting the foreground regions in a radar frame.

The detecting points d1 to dn acquired as described above are then used as measurements for the tracking in the further processing of the tracking loop.

In the first radar frame, there are no tracklets and no object-tracks, as the tracking loop is initialized with empty lists of tracklets and object-tracks. Consequently, in the first radar frame, the detection points d1 to dn are used to initialize the new tracklets t1 to tm that carry a tentative state.

In the following, the tracking loop according to an example of the present disclosure is described for a present non-first radar frame fp, in which the list of tracklets t1 to tm is not empty.

In the method step S2 of the tracking loop according to this example, one or a plurality of parameters of each tracklet t1 to tm is predicted for the present radar frame fp by propagating the dynamical system model.

The parameters of each tracklet t1 to tm may include a position and a velocity, an acceleration, and a covariance of the tracklet t1 to tm in a radar frame. The dynamical system model may be a simple constant-velocity model or a constant acceleration model as well. Propagating the constant-velocity model can be expressed as follows:

μ_{t|t-1}←μ_{t-1|t-1}+v_{t-1|t-1} (1)

v_{t|t-1}←v_{t-1|t-1} (2)

where μ_{t-1|t-1} indicates the corrected estimate at time t−1 and μ_{t|t-1} indicates the predicted estimate at time t. Propagating the constant-acceleration model can be expressed as follows:

μ_{t|t-1}←μ_{t-1|t-1}+v_{t-1|t-1}+0.5·a_{t-1|t-1} (3)

v_{t|t-1}←c_{t-1|t-1}+a_{t-|t-1} (4)

a_{t|t-1}←a_{t-1|t-1} (5)

where v_{t-1|t-1} indicates the corrected velocity estimate at time t−1, v_{t|t-1} indicates the predicted velocity estimate at time t and a_{t-1|t-1} indicates the corrected acceleration estimate at time t−1.

After the predicting of the parameters of each tracklet t1 to tm in method step S2, the detection points d1 to dn are associated to the tracklets t1 to tm in method step S3.

The associating of detection points d1 to dn to tracklets t1 to tm may involve using a gating procedure. In the gating procedure, a gate which is an association-region, such as a rectangle, a square, an ellipse, or a circle, is placed around the (predicted) center position of each tracklet t1 to tm. In this example, the association region is an ellipse fixed in size.

Then, after associating detection points d1 to dn to tracklets t1 to tm in method step S3, the tracklets t1 to tm are associated to object-tracks g1 to gk based on at least one feature-parameter, in method step S4. In this example, the tracklets t1 to tm are associated to object-tracks g1 to gk based on the overlap of the gates of the tracklets t1 to tm, wherein a DBSCAN method is used for grouping the tracklets t1 to tm into object-tracks.

In method step S5, the metadata of the tracklets t1 to tm is updated. In this example, the status of the tracklets t1 to tm is maintained, wherein the status may comprise a tentative state, a tracked state, a lost state, and completely lost state.

Furthermore, the metadata of the tracklets t1 to tm may comprise a track-count value and a lost-track-count value as well as a unique identification number that identifies which object-track g1 to gk the tracklet t1 to tm is associated to.

The rules for updating the status allow a tracklet t1 to tm to be lost for multiple radar frames, when there are no detection points that can be associated with the tracklet. Eventually, if the tracklet t1 to tm is lost for a predetermined period of time, the tracklet is considered to be in the completely lost state.

The track-count value is incremented in every iteration of the tracking loop in which the tracklet t1 to tm can be tracked, viz. detection points can be associated to the tracklet t1 to tm. The lost-track-count value is incremented in every iteration of the tracking loop in which the tracklet cannot be tracked, viz. no detection point can be associated to the tracklet t1 to tm.

Newly initialized tracklets t1 to tm first have a tentative state until the track-count value reaches a predetermined value, at which point the status of the tracklet is updated from a tentative state to a tracked state.

A tracklet in a tentative state to which no detection point is associated is immediately updated to the completely lost state and removed from the list of the tracklets t1 to tm.

If a tracklet has a tracked state and no detection points d1 to do can be associated to the tracklet, the status of the tracklet is updated to the lost state and incrementation of the lost-track-count value begins. As soon as a detection point can be associated to the tracklet t1 to tm again, the status of the tracklet is moved back to the tracked state and the track-count value as well as the lost-track-count value are reset to zero.

If the lost-track-count value of a tracklet reaches a predetermined value, it is updated to a completely lost state and removed from the list of tracklets.

In method step S6, any detection point that is not associated to tracklets t1 to tm is used to initialize new tracklets that carry a tentative state as described above. One new tracklet is initialized for each (unassociated) detection point. Most such tracklets are spurious and will be completely lost after a few iterations of the tracking loop.

In method step S7, the parameters of all active tracklets t1 to tm (which are tracklets having a tracked state), which are predicted in method step S2, are corrected. Said correction is based on the associated detections, according to rules that are heuristic or that arise as solutions to the Bayesian filtering equations corresponding to the assumed dynamical system models. In particular, synthetic observations are formed by weighted averaging of detection points:

$${\overline{x}}_{t} = \frac{{\sum }_{i = 1}^{N} {w}_{i} {x}_{t}^{i}}{{\sum }_{i = 1}^{N} {w}_{i}} \qquad ( 6 )$$

and the alpha-beta filter is applied as follows:

rₜ=x̅ₜ−μ_{t|t-1} (7)

μ_{t|t}=μ_{t|t-1}+α·rₜ (8)

v_{t|t}=v_{t|t-1}+β·rₜ (9)

a_{t|t}=a_{t|t-1}+2γ·rₜ (10)

where α, β and 2γ∈[0, 1] are adaption rates.

In method step S8, it is queried whether the tracking loop should be terminated, for instance, if the present radar frame is the last radar frame to be tracked. If the tracking should be continued, the method steps S1 to S7 are performed for the next radar frame. If the present radar frame is the last radar frame to be tracked, the tracking loop is terminated.

In the context of the order of the individual steps of the tracking loop, it shall be noted that the order of the method steps in the present example is non-limiting. Accordingly, the order of the individual method steps may be permuted if this is technically reasonable.

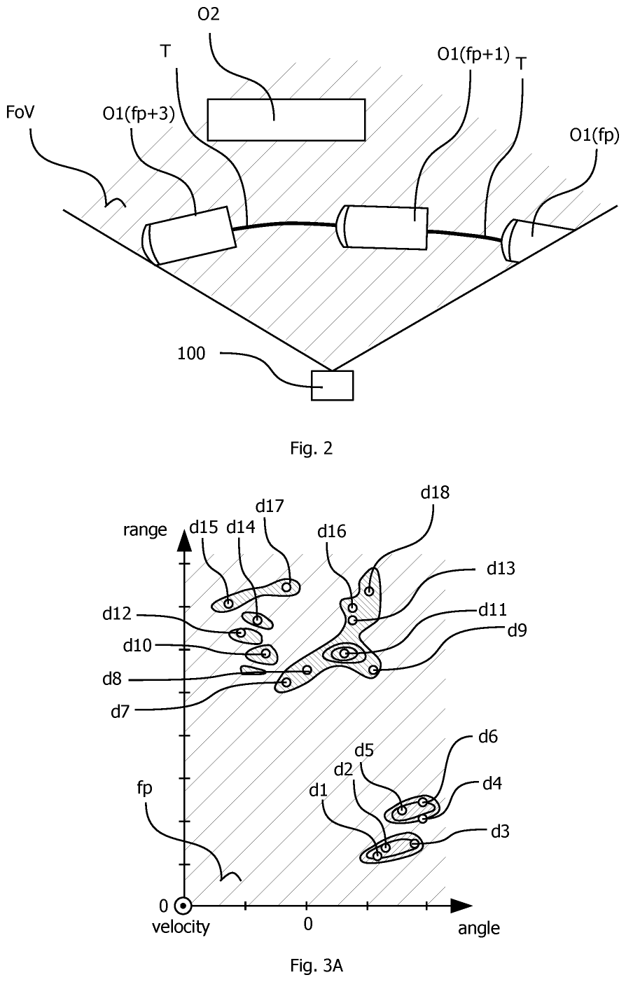

In FIG. 2, a schematic representation of an example of a radar system 100 according to the present disclosure is depicted. The radar system 100 is configured to acquire measurement data including a plurality of (consecutive) radar frames of a field of view FoV of the radar system 100.

In the field of view FoV of the radar system 100, a first moving object O1 can be observed over multiple radar frames, starting from a present radar frame fp. In FIG. 2, three different positions O1(fp), O1(fp+n, wherein n=1 in this example) and O1(fp+m, wherein m=3 in this example) of the moving object O1 are depicted along a trajectory T of the moving object O1.

Furthermore, a stationary object O2 is depicted in the field of view FoV of the radar system 100 in FIG. 2.

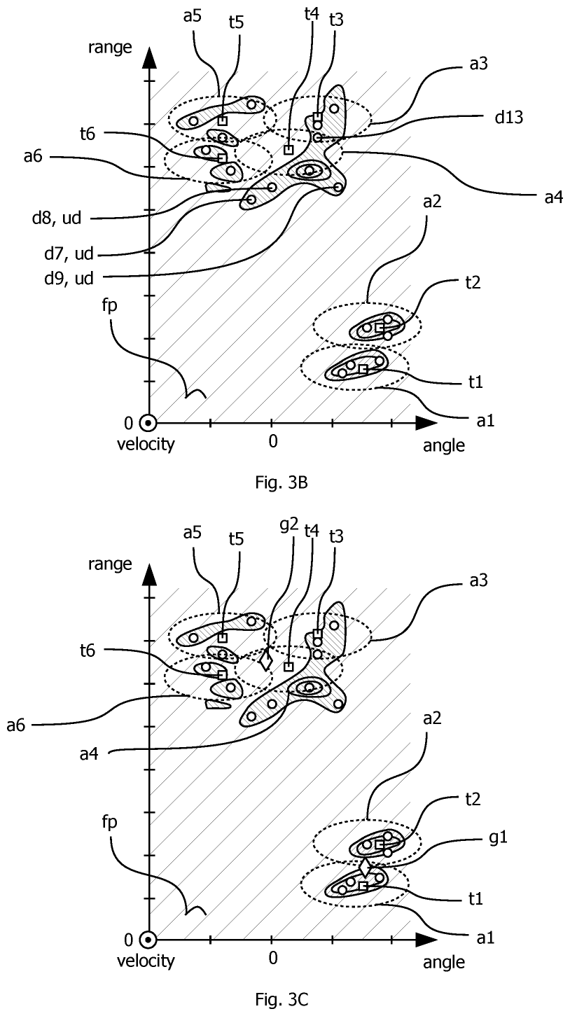

A present radar frame fp is depicted in FIGS. 3A to 3C as a radar-doppler-visualization, wherein the velocity is depicted as a heat map over the range and angle dimensions. In FIGS. 3A to 3C the background is extracted, for instance according to a method as described above.

Furthermore, detection points d1 to d16 are detected according to method step S1 and drawn in as circles in FIGS. 3A to 3C. The number of possible detection points according to the present disclosure is not limited to the number of detection points d1 to d18 in this example. The extracted background is depicted in a widely hatched area of FIGS. 3A to 3C.

In the example depicted in FIGS. 3A to 3C, a finely hatched area that is hatched from bottom right to top left represents velocities that are around zero. Moreover, a finely hatched area that is hatched from bottom left to top right represent velocities that are non-zero in the example depicted in FIGS. 3A to 3C.

In FIG. 3B, the dynamical system model is propagated according to method step S2 so that the predicted (center) positions of tracklets t1 to t6 are estimated. The predicted (center) positions of tracklets t1 to t6 are depicted as squares in FIG. 3B.

In FIG. 3B, the gates a1 to a6 of the tracklets t1 to t6 are drawn with a dotted line. In the example of FIGS. 3A to 3C, the gates a1 to a6 of the tracklets t1 to t6 are ellipses fixed in size. As explained above, the gates a1 to a6 of the tracklets t1 to t6 may also be adaptive in size.

The detection points d1 to d18 are associated to the tracklets t1 to t6 according to method step S3 of the tracking loop, as explained above. The detection points d7 to d9 are unassociated detection points ud, since the detection points d7 to d9 are not within any gate a1 to a6 of the tracklets t1 to t6.

In the example shown in FIG. 3B, detection point d13 is within two gates a3 and a4. Accordingly, detection point d13 is associated to tracklet t3, as the distance between detection point d13 and the predicted (center) position of the tracklet t3 is smaller than the distance between detection point d13 and the predicted (center) position of tracklet t4.

In FIG. 3C, the tracklets t1 to t6 are associated to the object-tracks g1 and g2 according to method step S4. In this specific example, a clustering method is used to cluster the tracklets t1 to t6 into object-tracks based on the overlap of the gates a1 to a6 of the tracklets t1 to t6 in the present radar frame. The object-tracks represent the objects to be tracked by the tracking loop. The centers of the object-tracks g1 and g2 are depicted in FIG. 3C as diamonds.

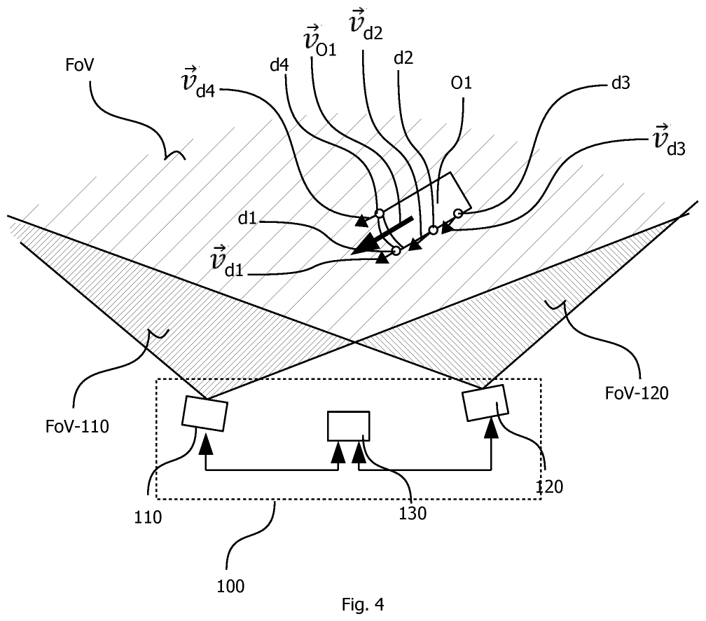

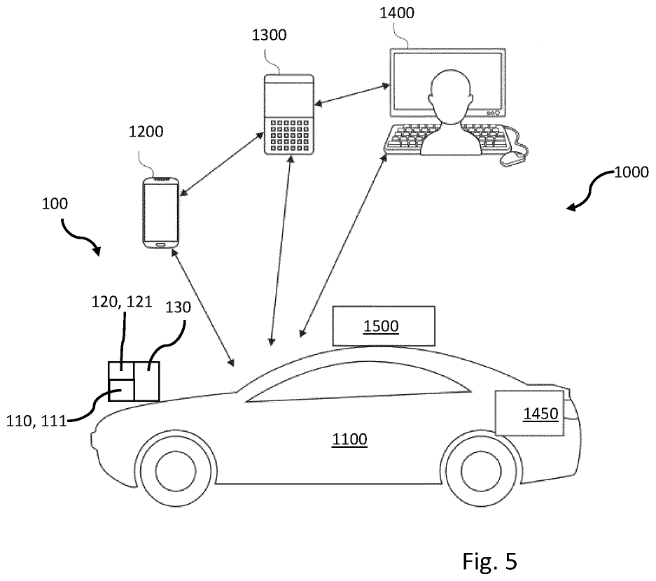

FIG. 4 shows a schematic representation of a further radar system 100 comprising a first radar unit 110 and a second radar unit 120. In this example, the radar system 100 further comprises a tracking computation unit 130 configured to process the acquired radar frames by performing the steps of the method as explained above.

It shall be noted that the tracking computation unit 130 may also be part of at least one of the radar units 110 and 120. In the example of FIG. 4, the radar units 110, 120 are configured to communicate the measurement data acquired by each radar unit 110, 120 to the tracking computation unit 130. The radar units 110, 120 are non-colocated radars, viz. the radar units 110, 120, for instance, do not share antennas in a larger antenna array.

The radar units 110, 120 each comprise a field of view FoV-110, FoV-120, wherein the field of views FoV-110, FoV-120 of the radar units 110, 120 at least partially (spatially) overlap in a field of view FoV of the radar system 100.

In the field of view FoV a moving object O1 with an actual velocity \vec{v}_{O1} is present and is observed by both radar units 110, 120. Strong, reliable reflection points of the object O1 in the scene (field of view FoV) are captured by both radar units 110, 120 to provide two radial velocity components.

The two radial velocity components of each detection point d1 to d4 can be resolved with a least-squares solution to estimate a two-dimensional velocity vector. A multidimensional velocity vector can be estimated accordingly, for instance, if the measurement data also comprises measurements in the elevation direction.

The computation of the two-dimensional or multi-dimensional velocity vector involves an interpolation operation between the range-angle grids of the radar units 110, 120. For each radar frame, a list of two-dimensional or multidimensional velocity vectors are appropriately scored according to the radar frames magnitudes (e.g. the minimum of the magnitudes of the radar units 110, 120).

In FIG. 4, four detection points d1 to d4 are depicted with the corresponding computed two-dimensional or multidimensional velocity vectors \vec{v}_{d1} to \vec{v}_{d4}.

The two-dimensional or multidimensional velocity vectors may be incorporated in the updating step S5, in the initializing step S6 and in the correcting step S7 of the tracking loop, as follows:

In the updating step S5, it is possible to improve the accuracy of the tracking loop. In particular, a transition between a tentative state and a tracked state of a tracklet can be expedited if the tracklet is inside an area around the position of a detection point for which a two-dimensional vector is determined, and if a comparison measure of the multidimensional velocity vector and multidimensional velocity vectors of the detection point's neighboring multidimensional velocity vectors, is equal to or greater than a predetermined threshold.

For example, a two-dimensional or multidimensional velocity vector that agrees with its neighbors about the direction of movement creates a so-called hotspot around the corresponding detection point of the two-dimensional or multidimensional velocity vector.

The so-called hotspot may, for instance, be an elliptical region, a rectangular region, a circular region, or the like in Cartesian coordinates.

The two-dimensional or multidimensional velocity vectors may be gated by position of the corresponding detection point around the two-dimensional or multidimensional velocity vectors, in order to identify the neighbors of the two-dimensional or multidimensional velocity vectors.

As a comparison measure hotᵢ, the normalized inner product of the velocity vectors with the neighbor's velocity vectors, may be computed and totaled. The totaled, normalized inner product of the velocity vectors hotᵢ may then compared with a predetermined threshold hotₜₕᵣₑₛₕ for determining whether a hotspot is created or not:

$${hot}_{i} = [ ( {\sum }_{j ∈ neigh} \frac{{v}_{i} \cdot {v}_{j}}{{‖ {v}_{i} ‖}_{2} {‖ {v}_{j} ‖}_{2}} ) \geq {hot}_{thresh} ] \qquad ( 11 )$$

The normalized inner product measures agreement about what direction the object in that location is moving in. The sum is an aggregate metric that, for a number n of velocity vectors, ranges from −n (perfect disagreement) over 0 (expected value if directions are uniformly random) to n (perfect agreement).

Similarly, in the initialization step S6, tracklets may be initialized more quickly with a tracked state, if two-dimensional or multidimensional velocity vectors of observed detection points are available.

Tracklets or object-tracks (groups of tracklets) can be initialized with a tracked state instead of a tentative state, if the same comparison measure holds.

This allows, for example, for both tracklets and object-tracks in one radar frame to be initialized with a tracked state for an object as long as the observed detection points and enough two-dimensional or multidimensional velocity vectors are in agreement within its neighborhood.

Moreover, the two-dimensional or multidimensional velocity vectors may be incorporated in the correcting step S7 of the tracking loop.

For example, the updating step S5 may be performed and then a further (separate) updating step may be performed based on nearby two-dimensional or multidimensional velocity vectors. Here, the tracklets that are corrected comprise velocity vectors as parameters, so that the center position and the velocity vector of the tracklet can be used to gate the position and velocity. Then a median over the gated two-dimensional or multidimensional velocity vectors can be computed to further reject outliers and update the velocity of the tracklet with an appropriately weighted convex combination:

vᵢ←ζ·vᵢ+(1ζ)·median(vecsᵢ) (12)

where ζ∈[0,1]. This median aggregation and convex combination step can also be used to warm-start the velocity of a tracklet that was initialized due to two-dimensional or multidimensional velocity vectors (as described above).

FIG. 5 shows a system 1000 comprising an autonomous vehicle 1100 and a radar system 100 according to embodiments. The radar system 100 comprises a first radar unit 110 with at least one first radar antenna 111 (for sending and/or receiving corresponding radar signals), a second radar unit 120 with at least one second radar antenna 121 (for sending and/or receiving corresponding radar signals) and a tracking computation unit 130.

The system 1000 may include a passenger interface 1200, a vehicle coordinator 1300, and/or a remote expert interface 1400. In certain embodiments, the remote expert interface 1400 allows a non-passenger entity to set and/or modify the behavior settings of the autonomous vehicle 1100. The non-passenger entity may be different from the vehicle coordinator 1300, which may be a server.

The system 1000 functions to enable the autonomous vehicle 1100 to modify and/or set a driving behavior in response to parameters set by vehicle passengers (e.g., via the passenger interface 1200) and/or other interested parties (e.g., via the vehicle coordinator 1300 or remote expert interface 1400). Driving behavior of an autonomous vehicle may be modified according to explicit input or feedback (e.g., a passenger specifying a maximum speed or a relative comfort level), implicit input or feedback (e.g., a passenger's heart rate), or any other suitable data or manner of communicating driving behavior preferences.

The autonomous vehicle 1100 is preferably a fully autonomous automobile, but may additionally or alternatively be any semi-autonomous or fully autonomous vehicle; e.g., a boat, an unmanned aerial vehicle, a driverless car, etc. Additionally, or alternatively, the autonomous vehicle may be a vehicle that switches between a semi-autonomous state and a fully autonomous state and thus, the autonomous vehicles may have attributes of both a semi-autonomous vehicle and a fully autonomous vehicle depending on the state of the vehicle.

The autonomous vehicle 1100 preferably includes a throttle interface that controls an engine throttle, motor speed (e.g., rotational speed of electric motor), or any other movement-enabling mechanism; a brake interface that controls brakes of the autonomous vehicle (or any other movement-retarding mechanism); and a steering interface that controls steering of the autonomous vehicle (e.g., by changing the angle of wheels of the autonomous vehicle). The autonomous vehicle 1100 may additionally or alternatively include interfaces for control of any other vehicle functions; e.g., windshield wipers, headlights, turn indicators, air conditioning, etc.

In addition, the autonomous vehicle 1100 preferably includes an onboard computer 1450.

The tracking computation unit 130 may be located at least in part in and/or on vehicle 1100 and may be (at least in part) integrated in onboard computer 1450 and/or may be (at least in part) integrated in a computation unit in addition to onboard computer 1450. Alternatively or in addition, tracking unit may be (at least in part) integrated in the first and/or second radar unit 110, 120. If the tracking unit 130 is provided (at least in part) in addition to onboard computer 1450, it may be in communication with onboard computer so that data may transmitted from tracking unit 130 to onboard computer 1450, and/or vice versa.

In addition or alternatively, the tracking computation unit 130 may be (at least in part) integrated in one or more or all of passenger interface 1200, vehicle coordinator 1300, and/or a remote expert interface 1400. In particular in such case, the radar system may comprise passenger interface 1200, vehicle coordinator 1300, and/or a remote expert interface 1400.

In addition to the one or two or more RADAR unit(s), the autonomous vehicle 1100 preferably includes a sensor suite 1500 (including e.g. one or more or all of a computer vision (“CV”) system, LIDAR, wheel speed sensors, GPS, cameras, etc.).

The onboard computer 1450 may be implemented as an ADSC and functions to control the autonomous vehicle 1100 and processes sensed data from the sensor suite 1500 and/or other sensors, in particular sensors provided by the radar units 110, 120, and/or data from the tracking computation unit 130, in order to determine the state of the autonomous vehicle 1100. Based upon the vehicle state and programmed instructions, the onboard computer 1450 preferably modifies or controls driving behavior of the autonomous vehicle 1100.

Driving behavior may include any information relating to how an autonomous vehicle drives (e.g., actuates brakes, accelerator, steering) given a set of instructions (e.g., a route or plan). Driving behavior may include a description of a controlled operation and movement of an autonomous vehicle and the manner in which the autonomous vehicle applies traffic rules during one or more driving sessions. Driving behavior may additionally or alternatively include any information about how an autonomous vehicle calculates routes (e.g., prioritizing fastest time vs. shortest distance), other autonomous vehicle actuation behavior (e.g., actuation of lights, windshield wipers, traction control settings, etc.) and/or how an autonomous vehicle responds to environmental stimulus (e.g., how an autonomous vehicle behaves if it is raining, or if an animal jumps in front of the vehicle). Some examples of elements that may contribute to driving behavior include acceleration constraints, deceleration constraints, speed constraints, steering constraints, suspension settings, routing preferences (e.g., scenic routes, faster routes, no highways), lighting preferences, “legal ambiguity” conduct (e.g., in a solid-green left turn situation, whether a vehicle pulls out into the intersection or waits at the intersection line), action profiles (e.g., how a vehicle turns, changes lanes, or performs a driving maneuver), and action frequency constraints (e.g., how often a vehicle changes lanes).

The onboard computer 1450 functions to control the operations and functionality of the autonomous vehicles 1100 and processes sensed data from the sensor suite 1500 and/or other sensors, in particular sensors provided by the radar units 110, 120, and/or data from the tracking computation unit 130 in order to determine states of the autonomous vehicles no. Based upon the vehicle state and programmed instructions, the onboard computer 1450 preferably modifies or controls behavior of autonomous vehicles 1100. The tracking computation unit and/or onboard computer 1450 is/are preferably a general-purpose computer adapted for I/O communication with vehicle control systems and sensor systems, but may additionally or alternatively be any suitable computing device. The onboard computer 1450 is preferably connected to the Internet via a wireless connection (e.g., via a cellular data connection). Additionally or alternatively, the onboard computer 1450 may be coupled to any number of wireless or wired communication systems.

The sensor suite 1500 preferably includes localization and driving sensors; e.g., photodetectors, cameras, SONAR, LIDAR, GPS, inertial measurement units (IMUs), accelerometers, microphones, strain gauges, pressure monitors, barometers, thermometers, altimeters, etc.

In one example embodiment, any number of electrical circuits of FIG. 5, in particular as part of the tracking computation unit 130, the onboard computer 1450, passenger interface 1200, vehicle coordinator 1300 and/or remote expert interface 1400 may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow one or more processors to carry out those functionalities.

### LIST OF REFERENCE SIGNS

S0 method step of initializing the tracking loop;
S1 method step of detecting detection points in the present radar frame;
S2 method step of predicting one or a plurality of parameters of each tracklet;
S3 method step of associating the detection points to the tracklets;
S4 method step of associating the tracklets to the object-tracks;
S5 method step of updating the metadata of the tracklets;
S6 method step of initializing new tracklets;
S7 method step of correcting the parameters of the tracklets;
S8 method step of querying whether the present radar frame is the last radar frame to be processed;
a1 to al gates (association areas) of the tracklets;
d1 to dn detection points;
t1 to tm tracklets;
g1 to gk object-tracks;
ud unassociated detection point;
fp present radar frame;
fp+1 radar frame subsequent to the present radar frame;
fp+2 radar frame further subsequent to the present radar frame;
O1, O2 first and second objects;
O1(fp) first object in a present radar frame;
T trajectory;
FoV field of view of the radar system;
FoV-110 field of view of the first radar unit;
FoV-120 field of view of the second radar unit;
\vec{v}_{O1} actual velocity of the object;
\vec{v}_{d1 to dn} two-dimensional or multidimensional velocity vectors of a detection point;
100 radar system;
110 first radar unit;
111 first radar antenna;
120 second radar unit;
121 second radar antenna;
130 tracking computation unit
1000 system
1100 vehicle
1200 passenger interface 1200
1300 vehicle coordinator 1300
1400 remote expert interface
1450 onboard computer
1500 sensor suite

The above description of illustrated embodiments is not intended to be exhaustive or limiting as to the precise forms disclosed. While specific implementations of, and examples for, various embodiments or concepts are described herein for illustrative purposes, various equivalent modifications may be possible, as those skilled in the relevant art will recognize. These modifications may be made considering the above detailed description or Figures.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

In certain contexts, the features discussed herein can be applicable to automotive systems (in particular autonomous vehicles, preferably autonomous automobiles), (safety-critical) industrial applications, and industrial process control.

Moreover, certain embodiments discussed above for tracking at least one object in measurement data of a radar system can be provisioned in digital signal processing technologies for medical imaging, automotive technologies for safety systems (e.g., stability control systems, driver assistance systems, braking systems, infotainment and interior applications of any kind).

Parts of various systems for tracking at least one object in measurement data of a radar system as proposed herein can include electronic circuitry to perform the functions described herein. In some cases, one or more parts of the system can be provided by a processor specially configured for carrying out the functions described herein. For instance, the processor may include one or more application specific components, or may include programmable logic gates which are configured to carry out the functions describe herein. The circuitry can operate in analog domain, digital domain, or in a mixed-signal domain. In some instances, the processor may be configured to carrying out the functions described herein by executing one or more instructions stored on a non-transitory computer-readable storage medium.

In one example embodiment, any number of electrical circuits of the present FIGS. may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

1. A method for tracking at least one object in measurement data of a radar system including a plurality of, in particular consecutive, radar frames acquired by a radar system, comprising:
detecting detection points in the radar frames;
associating the detection points of a present radar frame to a plurality of tracklets, wherein each tracklet is a track of at least one detection point observed over multiple radar frames; and
associating the tracklets based on at least one feature-parameter to at least one object-track.

2. The method according to claim 1,
wherein obtaining and/or maintaining the tracklets and the object-tracks is based on at least one dynamical system model.

3. The method according to claim 1, further comprising:
predicting one or a plurality of parameters of each tracklet for the present radar frame by propagating the dynamical system model, wherein the parameters of each tracklet include at least a position, in particular a position and a velocity, preferably a position and a velocity and an acceleration, and a covariance of the tracklet in a radar frame; and
correcting the parameters of each tracklet based on the detection points that are associated to the corresponding tracklet,
wherein the predicting is performed before the associating of the detection points to the tracklets and the correcting is performed after the associating of the detection points to the tracklets.

4. The method according to claim 1,
wherein in the associating of the detection points to tracklets, a detection point is associated to a tracklet, if a position of the detection point is within a gate of a tracklet,
wherein new tracklets are initialized from the detection points whenever the criterion for assignment of a detection is not met for any of the existing tracklets, in particular if a position of a detection point is outside the gates of all existing tracklets.

5. The method according to claim 4,
wherein a gate for each tracklet is either fixed in size or is adaptive in size, wherein the size of the gate correlates with the covariance of the tracklet, in particular such that the size of the gate is increased if the covariance increases, and vice versa.

6. The method according to claim 1,
wherein in the associating of the detection points to the tracklets, a detection point is associated to the tracklet having a position closest to the detecting point.

7. The method according to claim 1,
wherein in the associating of the detection points to tracklets, a detection point is probabilistically associated to multiple tracklets,
wherein probabilistic values determining the probability that a detection point is associated to a tracklet are increased if the distance between the position of the detection point and the predicted position of the tracklet decreases, and vice versa.

8. The method according to claim 1,
wherein the feature-parameter for the grouping of the tracklets, based on which the tracklets are clustered into the object-tracks, comprises an overlap of the gates of the individual tracklets in at least the present radar frame and/or a summed overlap of the gates of the individual tracklets in multiple previous radar frames.

9. The method according to claim 1,
wherein the grouping of the tracklets is performed by a clustering method, in particular by a DBSCAN method.

10. The method according to claim 1,
further comprising correcting parameters of the object-track, in particular, a position, a velocity and/or an acceleration of the object-track, by updating the parameters of the object-track based on a predicted velocity and/or a predicted acceleration of the tracklets of the corresponding object-track.

11. The method according to claim 1,
wherein each tracklet comprises metadata including at least one of a status of the tracklet, a track-count value and a lost-track-count value.

12. The method according to claim 11, further comprising:
updating the metadata of the tracklets; and
initializing detection points as new tracklets that are not associated to existing tracklets,
wherein the updating of the metadata and the initializing of detection points as new tracklets are performed after the associating of the detection points to the tracklets.

13. The method according to claim 1,
wherein an alpha-beta filter is used for modelling the dynamics of the tracklets and a Kalman filter is used for modelling the dynamics of the object-tracks, or, wherein an alpha-beta filter is used for modelling the dynamics of the tracklets and the object-tracks.

14. The method according to claim 1,
wherein an object model is inferred from a library of object models for each object-track and a switching Kalman filter is used for modelling the object-tracks, wherein a switch state of the switching Kalman filter represents an object class.

15. The method, in particular according to claim 1, for tracking at least one object in measurement data of a radar system including a plurality of, in particular consecutive, radar frames acquired by a radar system, comprising:
detecting detection points in the radar frames (fp);
wherein the plurality of radar frames comprised in the measurement data is a first plurality of radar frames acquired by a first radar unit,
wherein the measurement data further includes a second plurality of radar frames acquired by a second radar unit that is non-colocated to the first radar unit,
wherein the first and the second plurality of radar frames are synchronized and at least partially overlap,
wherein the radar frames contain range, doppler and angle measurements,
wherein a multidimensional velocity vector is determined from the doppler measurements for at least one, in particular for multiple, preferably for each detection point that is detectable in synchronized radar frames of the first and the second plurality of radar frames, wherein the determining of the multidimensional velocity vector is based on the corresponding doppler measurements of the first and the second radar units.

16. The method according to claim 15,
wherein the multidimensional velocity vectors are used in a correcting of parameters of a track, in particular in the correcting of the parameters of the tracklet.

17. The method according to claim 15,
wherein the multidimensional velocity vectors are used in an updating of metadata of a track and in an initializing of detection points as new tracks, in particular in the updating of the metadata of the tracklets and in the initializing of detection points as new tracklets.

18. The method according to claim 15,
wherein the status of a track is changed immediately from a tentative state to a tracked state if the track is inside an area around the position of a detection point for which a multidimensional vector is determined, and if a comparison measure, in particular a sum of the inner product, of the multidimensional velocity vector and multidimensional velocity vectors of the detection point's neighboring multidimensional velocity vectors is equal or greater than a predetermined threshold,
in particular wherein the status of a tracklet is changed immediately from a tentative state to a tracked state if the tracklet is inside an area around the position of a detection point for which a multidimensional vector is determined, and if a comparison measure, in particular a sum of the inner product, of the multidimensional velocity vector and multidimensional velocity vectors of the detection point's neighboring multidimensional velocity vectors is equal or greater than a predetermined threshold.

19. The radar system configured to track at least one object in measurement data of the radar system including a plurality of, in particular consecutive, radar frames using the method according to claim 1, comprising:
a first radar unit configured to acquire a plurality of radar frames by transmitting and receiving radar signals reflected on potential objects to be tracked in a field-of-view of the first radar unit; and
a tracking computation unit configured to process the acquired radar frames.

20. The radar system according to claim 19, further comprising:
a second radar unit configured to acquire a plurality of radar frames by transmitting and receiving radar signals reflected on potential objects to be tracked in a field-of-view of the second radar unit,
wherein the field of view of the first radar unit and the field-of-view of the second radar unit at least partially overlap.

21. A vehicle in which a radar system according to claim 19 is mounted, wherein the vehicle is an aircraft or watercraft or land vehicle, wherein the vehicle is either manned or unmanned.
